(19) United States
(12) Patent Application Publication
(10) Pub. No.: US 2025/0081164 A1
(43) Pub. Date: Mar. 6, 2025

(54) WIRELESS NETWORK CHANNEL USAGE

(71) Applicant: Cisco Technology, Inc., San Jose, CA (US)

(72) Inventors: Brian D. HART, Sunnyvale, CA (US); Malcolm M. SMITH, Richardson, TX (US); Binita GUPTA, San Diego, CA (US)

(21) Appl. No.: 18/825,034

(22) Filed: Sep. 5, 2024

Related U.S. Application Data
(60) Provisional application No. 63/580,603, filed on Sep. 5, 2023.

(51) Int. Cl. H04W 72/02; H04W 88/08

(52) U.S. Cl. CPC H04W 72/02; H04W 88/08

(57) ABSTRACT

The present disclosure describes an access point that coordinates infrastructure and non-infrastructure communications. The access point includes one or more memories and one or more processors communicatively coupled to the one or more memories. The one or more processors determine that access points of an extended service set are refraining from using a first channel and communicate, to a first device, a first beacon comprising a channel usage element indicating that the first channel is available for the first device to use to communicate directly with a second device.

### CROSS-REFERENCE TO RELATED APPLICATIONS

This application claims benefit of co-pending U.S. provisional patent application Ser. No. 63/580,603 filed Sep. 5, 2023. The aforementioned related patent application is herein incorporated by reference in its entirety.

### TECHNICAL FIELD

Embodiments presented in this disclosure generally relate to wireless communication. More specifically, embodiments disclosed herein wireless network channel usage.

### BACKGROUND

Access points provide wireless access to network deployments, which may also be referred to as enterprise networks or infrastructure networks. Devices near the access points may form peer-to-peer (P2P) networks (which may also be referred to as non-infrastructure networks) that the devices use to directly communicate with each other (e.g., bypassing the access points). The infrastructure networks and non-infrastructure networks may have their own quality of service (QOS) goals achieved via independent scheduling and coordination procedures. When the infrastructure networks and non-infrastructure networks happen to use the same channels, however, such independent scheduling and coordination may result in QoS goals not being met. For example, some infrastructure networks may reserve a channel for critical traffic that is subject to QoS requirements. Non-infrastructure networks operating near the infrastructure networks may interfere with that channel and cause the critical traffic to not meet the QoS requirements.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point or device in the system of FIG. 1A.

FIGS. 2A through 2C illustrate example operations performed by the system of FIG. 1A.

FIG. 3 illustrates an example message in the system of FIG. 1A.

FIG. 4 is a flowchart of an example method performed by the system of FIG. 1A.

FIG. 5 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an access point that coordinates infrastructure and non-infrastructure communications. According to an embodiment, the access point includes one or more memories and one or more processors communicatively coupled to the one or more memories. The one or more processors determine that access points of an extended service set are refraining from using a first channel and communicate, to a first device, a first beacon comprising a channel usage element indicating that the first channel is available for the first device to use to communicate directly with a second device.

According to another embodiment, a method includes determining that access points of an extended service set are refraining from using a first channel and communicating, to a first device, a first beacon comprising a channel usage element indicating that the first channel is available for the first device to use to communicate directly with a second device.

According to another embodiment, an apparatus includes one or more memories and one or more processors communicatively coupled to the one or more memories. The one or more processors receive, from a first access point, a first beacon that includes a channel usage element indicating that a first channel is available for non-infrastructure communications and based on the first beacon, communicate a message directly to a device using the first channel.

### Example Embodiments

The present disclosure describes an access point that coordinates infrastructure and non-infrastructure communications. Generally, the access point determines a channel that is not being used by access points in the infrastructure network (e.g., access points that are in the same extended service set (ESS) or nearby access points in the same ESS). The access point may then communicate a message (e.g., broadcast a beacon, probe response, an association response, or a reassociation response) that includes a channel usage element that identifies the channel, which indicates to nearby devices that the channel is available for non-infrastructure communications (e.g., P2P communications). The devices may then use that channel to communicate messages directly to each other (e.g., bypassing the infrastructure network).

Additionally, the access point may determine another channel that should be reserved for critical traffic that is subject to quality of service (Qos) requirements. The channel usage element in the message (or another message) may also identify this channel to indicate that this channel is reserved for the critical traffic. The devices may then use this channel to communicate the critical traffic with the access point.

In certain embodiments, the access point provides several technical advantages. For example, the access point reduces interference caused by non-infrastructure communications on infrastructure communications, and vice versa. As another example, the access point improves the likelihood that critical traffic satisfies the QoS requirements.

Generally, “infrastructure communications” relates to communications first to a local (typically fixed) access point or networking equipment and typically provides connectivity with an intranet and then the Internet. Non-infrastructure communications does not use a local (typically fixed) access point or networking equipment. Non-infrastructure communications includes P2P communications, which includes communications directly to other endpoints or devices, and typically, P2P communications provide no further connectivity. Moreover, an infrastructure basic service set (BSS) is an 802.11 architecture that includes an access point, and the infrastructure BSS may be used for both infrastructure communications and non-infrastructure (e.g., P2P) communications.

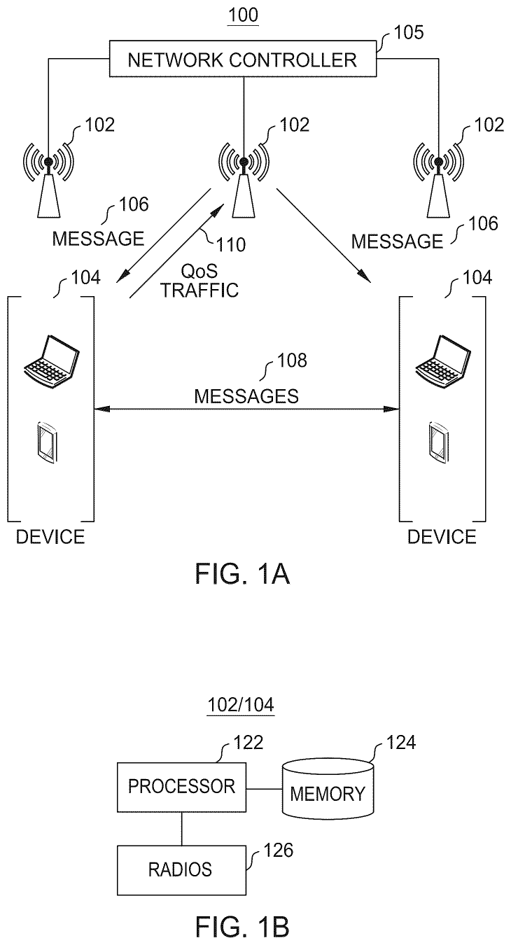

FIG. 1A illustrates an example system 100, which may be a network deployment that provides wireless communication (e.g., wireless fidelity (Wi-Fi) communications). As seen in FIG. 1A, the system 100 includes one or more access point 102 and one or more devices 104. Generally, an access point 102 detects a channel that is not being used for infrastructure communications and informs the devices 104 that the channel is available for non-infrastructure communications. The devices 104 may then use that channel for their non-infrastructure communications (e.g., P2P communications).

The access point 102 facilitates wireless communication in the system 100. A device 104 may connect to the access point 102. The access point 102 may then facilitate wireless communication for the device 104. For example, the device 104 may communicate a message or data stream to the access point 102. The access point 102 may route the message or data stream towards its destination. As another example, the access point 102 may receive a message or data stream for the device 104. The access point 102 may direct the message or data stream to the device 104.

The access points 102 in the system 100 may belong to the same extended service set (ESS). In this configuration, the access points 102 operate together to form a wireless network that appears to the devices 104 as a single, seamless network. Each access point 102 may provide coverage for a different physical space, effectively extending the coverage area of the network. The devices 104 may freely move or roam throughout the spaces covered by the access points 102 without losing connection to the network.

The access points 102 may implement or provide different channels over which the access points 102 communicate with the devices 104. Each channel is a frequency range that the access points 102 and/or the devices 104 use to transmit and receive signals and messages. An access point 102 may analyze the channels to determine which channels are being used by the access points 102 in the ESS (or by nearby access points 102 in the ESS) to communicate and which channels are not being used by the access points 102 in the ESS (or by nearby access points 102 in the ESS) to communicate.

In some embodiments, the system 100 includes a network controller 105 that manages or controls the access points 102. For example, the network controller 105 may coordinate the communications from the access points 102. As another example, the network controller 105 control the access points 102 to use certain channels and to refrain from using certain channels. In this manner, the network controller 105 may free up certain channels for non-infrastructure communications. The network controller 105 may also inform the access points 102 about which channels are not being used by the access points and can support non-infrastructure communications. The access points 102 may then inform the devices 104 about these channels.

The access point 102 may then inform the devices 104 about a channel that (nearby) access points 102 in the ESS are not using so that the devices 104 may use that channel for non-infrastructure communications (e.g., traffic that is subject to QoS requirements and/or traffic that is not subject to QoS requirements). In the example of FIG. 1A, the access point 102 communicates or broadcasts a message 106 to the devices 104. The message 106 may be a beacon, a probe response, a (re) association response, etc. The message 106 may identify a channel that the (nearby) access points 102 in the ESS are not using for infrastructure communications, which may signal to the devices 104 that the channel is available for the devices 104 to use for non-infrastructure communications (e.g., P2P communications). In some embodiments, the access point 102 communicates multiple messages 106 (e.g., beacons, probe responses, and (re) association responses) to inform the devices 104 about the channel.

The devices 104 then communicate directly with each other using the channel(s) indicated in the message 106. For example, the devices 104 may communicate messages 108 directly to each other using that channel, bypassing the access points 102. By using the indicated channel for the non-infrastructure communications, the devices 104 avoid interfering with infrastructure communications on other channels. In some instances, access points 102 in the same ESS that are far away from the devices 104 may still use the indicated channel because the access points 102 are too far from the devices 104 for the non-infrastructure communications between the devices 104 to interfere with the access points 102. As an example operation, a first device 104 hears the message 106 and starts a BSS on a channel indicated in the message 106. A second device 104 scans for the first device 104. If the second device 104 heard the message 106, the second device's 104 scanning might prioritize the channel(s) indicated in the message 106. When the second device 104 detects the first device's 104 transmissions (e.g. beacons or probe responses) on a channel, then the second device 104 connects with the first device 104 on the first device's 104 channel, which is one of the channels listed in the message 106.

In some embodiments, the message 106 from the access point 102 also indicates a channel that the devices 104 can use to communicate QoS traffic 110. The QoS traffic may be infrastructure communications that include traffic that is subject to QoS requirements (e.g., videoconferencing traffic, virtual reality traffic, etc.). The devices 104 may analyze the message 106 to determine the channel for QoS traffic 110. The devices 104 may then communicate the QoS traffic with the access point 102 using the indicated channel.

FIG. 1B illustrates an example access point 102, device 104, or network controller 105 in the system 100 of FIG. 1A. As seen in FIG. 1B, the access point 102, device 104, or network controller 105 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the access point 102, device 104, or network controller 105. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 102, device 104, or network controller 105 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 102, device 104, or network controller 105 may use one or more of the radios 126 for Wi-Fi communications. The access point 102, device 104, or network controller 105 may use one or more of the radios 126 to transmit messages and one or more of the radios 126 to receive messages. The access point 102, device 104, or network controller 105 may include any number of radios 126 to communicate using any number of communication technologies.

The access point 102, device 104, or network controller 105 may include any number of (e.g., one or multiple) processors 122 and memories 124. Generally, one or multiple processors 122 are considered to perform an operation (or configured to perform the operation) if (i) at least one of the processors 122 individually performs every step of the operation or (ii) multiple processors 122 collectively perform the steps of the operation (e.g., if one processor 122 performs the first half of the operation and another processor 122 performs the second half of the operation). Additionally, one or multiple memories 124 are considered to perform an operation (or configured to perform the operation) if (i) at least one of the memories 124 individually performs every step of the operation or (ii) multiple memories 124 collectively perform the steps of the operation (e.g., if one memory 124 performs the first half of the operation and another memory 124 performs the second half of the operation).

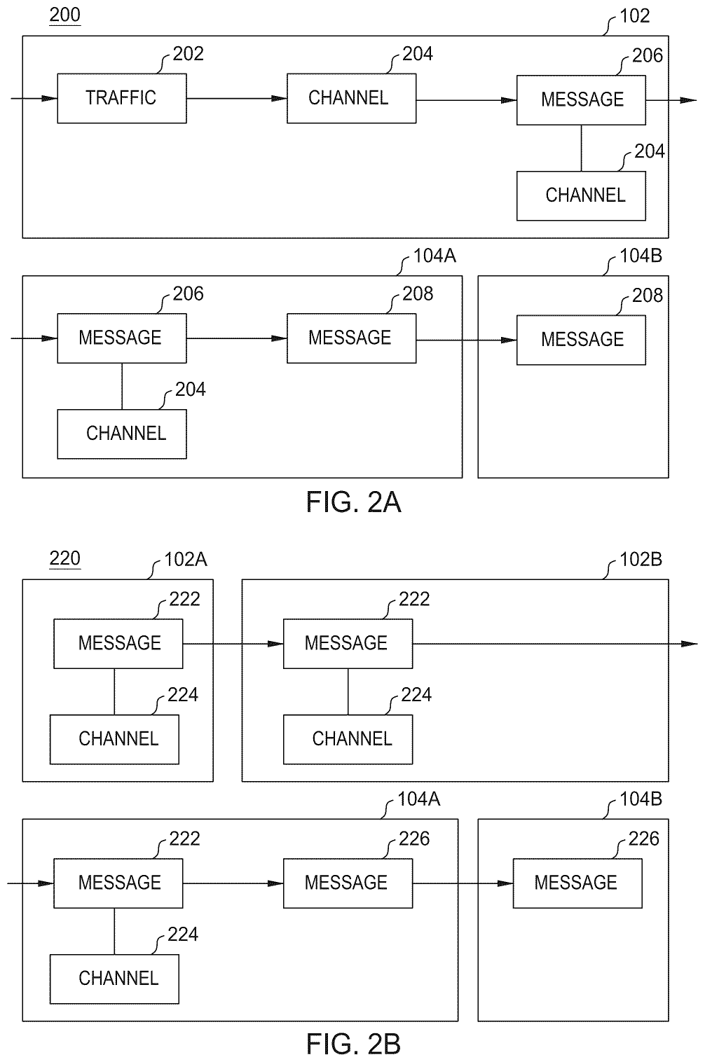

FIGS. 2A through 2C illustrate example operations performed by the system 100 of FIG. 1A. Generally, an access point and a device (e.g., the access point 102 and the device 104 shown in FIG. 1A) perform these operations to coordinate infrastructure communications and non-infrastructure communications.

FIG. 2A shows an example operation 200 performed by the access point 102 and the devices 104A and 104B. The access point 102 begins by receiving traffic 202. The traffic 202 may be communicated by the access points 102 and/or the devices 104 in the system. The access point 102 may receive the traffic 202 from a device or another access point. In some instances, the access point 102 receives the traffic 202 by scanning and analyzing the signals in the network or space.

The access point 102 analyzes the traffic 202 to determine various information about the traffic 202. For example, the access point 102 may determine whether the traffic 202 includes infrastructure communications (e.g., involves an access point in the network) or non-infrastructure communications. As another example, the access point 102 may determine the channels used to communicate the traffic 202. By analyzing the traffic 202, the access point 102 determines a channel 204 that is not being used by access points in the ESS for infrastructure communications. For example, the access point 102 may determine that the traffic 202 includes infrastructure communications and that none of the infrastructure communications is being communicated over the channel 204.

In some embodiments, a network controller (e.g., the network controller 105 shown in FIG. 1A) may determine a channel that should be used for non-infrastructure communications. The network controller then instructs the access point 102 (and other nearby access points in the ESS) to reserve the channel for non-infrastructure communications. The access point 102 may then refrain from communicating using that channel and may indicate to the devices 104 that the channel is available for non-infrastructure communications.

In certain embodiments, the access point 102 may discover nearby access points using the traffic 202, which may include the beacons, neighbor discovery packets, etc. from the nearby access points. The access point 102 then informs the network controller about the nearby access points. The network controller may then instruct the access point 102 and the nearby access points to reserve a channel for non-infrastructure communications. The access point 102 and the nearby access points may then inform devices 104 that the channel is available for non-infrastructure communications. If there are no nearby access points, then the network controller may instruct the access point 102 to reserve the channel, and the access point 102 may inform devices 104 that the channel is available for non-infrastructure communications.

The access point 102 may then determine that the channel 204 is available for non-infrastructure communications. The access point 102 generates a message 206 that indicates the channel 204. For example, the message 206 may include an identifier or a frequency range of the channel 204. The message 206 may also include an indicator that the channel 204 is available for non-infrastructure communications. The access point 102 communicates the message 206 to inform the devices in the system that the channel 204 is available for non-infrastructure communications. In some embodiments, the message 206 is a beacon, a probe response, or an (re) association response, and the access point 102 broadcasts the message 206 to multiple devices in the system.

The device 104A may receive the message 206 from the access point 102. The device 104A analyzes the contents of the message 206 to determine that the message 206 indicates that the channel 204 is available for non-infrastructure communications. The device 104A may then generate a message 208 that includes non-infrastructure communications and communicate the message 208 directly to the device 104B using the channel 204, bypassing the access point 102. For example, the message 208 may be a P2P communication between the device 104A and the device 104B. Similarly, the device 104B may send non-infrastructure communications directly to the device 104A using the channel 204. In this manner, the devices 104A and 104B may send and receive non-infrastructure communications without interfering with the infrastructure communications of the access point 102, which improves the performance of the system.

In some embodiments, the device 104A may first start a BSS and send a discovery message (e.g., a beacon) using or within the channel 224. The device 104B may receive the discovery message and learn about the BSS and the channel 224. The device 104A and the device 104B may then use the channel 224 for non-infrastructure communications.

Access points in the system and/or a network controller may also indicate to each other that a channel is available for non-infrastructure communications. FIG. 2B shows an example operation 220 performed by the access points 102A and 102B and the devices 104A and 104B. The access point 102A begins by generating a message 222 that indicates that a channel 224 is available for non-infrastructure communications. The access point 102A may have determined that the channel 224 is available for non-infrastructure communications by analyzing traffic and determining that the access points in the ESS are not communicating over the channel 224. The access point 102A communicates the message 222 to the access point 102B to communicate to the access point 102B that the channel 224 is available for non-infrastructure communications. The access point 102B may be in the same ESS as the access point 102A, and the access point 102B may provide coverage for a different area than the access point 102A. The message 222 may be a beacon, a probe response, an (re) association response, etc.

The access point 102B receives the message 222 and communicates the message 222 to devices in the area of the access point 102B. For example, the access point 102B may broadcast, groupcast, or multicast the message 222 as a beach, probe response, (re) association response, etc. In some instances, the access point 102B may generate and broadcast a new message based on the message 222. By communicating the message 222 (or a new message), the access point 102B informs devices in the area of the access point 102B that the channel 224 is available for non-infrastructure communications. In certain embodiments, the access point 102B verifies that no access points near the access point 102B are using the channel 224 before transmitting the message 222 to the devices 104. In this manner, the access point 102B verifies that the non-infrastructure communications will not interfere with access points near the access point 102B. In some instances, if the access point 102B is using the channel 224 when the access point 102B receives the message 222, then the access point 102B may clear or reserve the channel 224 for non-infrastructure communications (e.g., moving communications over the channel 224 to another channel).

The device 104A may receive the message 222 from the access point 102B. The device 104A analyzes the contents of the message 222 to determine that the message 222 indicates that the channel 224 is available for non-infrastructure communications. The device 104A may then generate a message 226 that includes non-infrastructure communications and communicate the message 226 directly to the device 104B using the channel 224, bypassing the access points 102A and 102B. For example, the message 226 may be a P2P communication between the device 104A and the device 104B. Similarly, the device 104B may send non-infrastructure communications directly to the device 104A using the channel 224. In this manner, the devices 104A and 104B may send and receive non-infrastructure communications without interfering with the infrastructure communications of the access point 102, which improves the performance of the system. As with previous examples, the device 104A may first start a BSS and communicate a discovery message. The device 104B may receive the discovery message and learn about the BSS and the channel 224.

As discussed previously, the access points may also inform the devices of channels that the devices may use to communicate traffic that is subject to QoS requirements (e.g., videoconferencing traffic, virtual reality traffic, control traffic for automated manufacturing, etc.). FIG. 2C shows an example operation 240 performed by the access point 102 and the device 104. The access point 102 begins by determining a channel 242 that is available for traffic subject to QoS requirements, which may also be referred to as QoS traffic. For example, the access point 102 (or a network controller) may have reserved the channel 242 for QoS traffic, or the access point 102 may have set up the channel 242 to prioritize QoS traffic. The access point 102 generates a message 244 that indicates that the channel 242 is available for QoS traffic. The access point 102 then communicates the message 244 to devices 104. For example, the message 244 may be a beacon, a probe response, an (re) association response, etc. that the access point 102 broadcasts to devices in the coverage area of the access point 102. In some embodiments, other access points in the same ESS as the access point 102 may determine, from the message 244, that the channel 242 is available for QoS traffic. These access points may then use the channel 242 to communicate QoS traffic. In another embodiment, other access points in the same ESS as the access point 102 may determine, from the message 244, that the channel 242 is reserved for QoS traffic. These access points may then avoid using the channel 242 and may find another channel not in use by other nearby access points and use that channel for QoS traffic.

The device 104 receives the message 244 from the access point 102. The device 104 analyzes the message 244 to determine that the channel 242 is available for the device 104 to use to communicate QoS traffic with the access point 102. When the device 104 has QoS traffic to communicate, the device 104 generates a message 246 that includes the QoS traffic and communicates the message 246 to the access point 102 using the channel 242. The access point 102 then receives the message 246 over the channel 242 and directs the message 246 towards its destination. When the access point 102 has QoS traffic to communicate, the access point 102 generates a message that includes the QoS traffic and communicates the message to the device 104 using the channel 242. The device 104 may then receive that message over the channel 242.

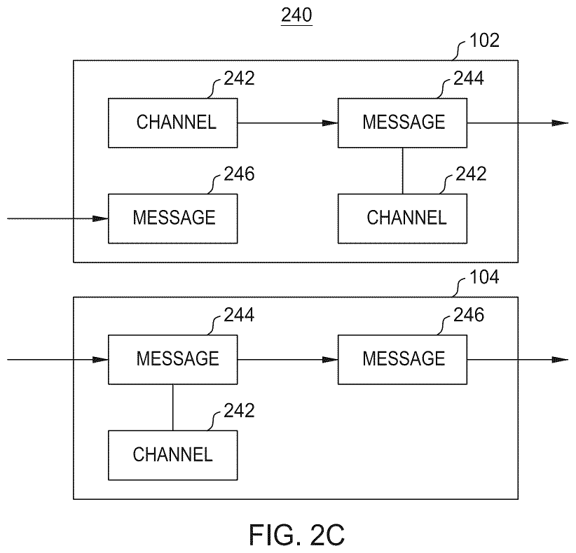

FIG. 3 illustrates an example message 206 in the system 100 of FIG. 1A.

As discussed above, the access point communicates the message 206 to indicate that a channel is available for non-infrastructure communications. Generally, the access point uses a channel usage element in the message 206 to indicate the availability of the channel. As seen in FIG. 3, the message 206 includes a channel usage element 302, which occupies a portion of the message 206. The channel usage element 302 includes an element identifier field 304, a length field 306, a usage mode field 308, and a channel entry field 310 that indicates one or more channels. The element identifier field 304 may be an octet that includes a value that identifies the element as a channel usage element. The length field 306 may be an octet that includes a value indicating the length of the remainder of the channel usage element 302. The message 206 may include multiple channel usage elements 302 that include separate and/or different element identifier fields 304, length fields 306, usage mode fields 308, and channel entry fields 310.

The usage mode field 308 may indicates the usage of channels identified in the channel entry field 310. The access point may use values in the usage mode field 308 to indicate that: a) channel(s) identified in the channel entry field 310 are available for non-infrastructure communications and it is unspecified whether the channel(s) are shared or not with other nearby APs in the ESS, b) channel(s) identified in the channel entry field 310 are available for non-infrastructure communications and the channel(s) are not shared with other nearby APs in the ESS, c) channel(s) identified in the channel entry field 310 are available for infrastructure QoS communications, and/or channel(s) identified in the channel entry field 310 are available for non-infrastructure QoS communications. For example, a certain value of the usage mode field 308 may indicate that a channel is available for non-infrastructure communications and that none of the (nearby) access points in the ESS operate on the channel. As a result, this value indicates that the channel is available and well-suited for non-infrastructure communications. As another example, a certain value of the usage mode field 308 may recommend that a particular channel be used for critical traffic (e.g., QoS traffic) with an infrastructure AP. The access point may transmit multiple Channel Usage elements, each one with a different values in the usage mode field 308 to indicate the availability of channel(s) for different types of communication or traffic.

The channel entry field 310 may identify one or more channels. For example, the channel entry field 310 may include a list of duples, with each duple identifying an operating class (e.g., a frequency band) and a channel number for that operating class.

In certain embodiments, the message 206 includes a message integrity check (MIC) field 312. Generally, the MIC field 312 prevents the message 206 from bit flip attacks, which improves the security of the message 206. The access point may add the MIC field 312 to implement the MIC. If included, the access points calculates the contents of the MIC field 312 based on the contents of the message 206. The MIC field 312 may be included in a beacon, which makes the beacon a source of trusted information. Thus, by including the channel usage element(s) 302 in the message 206 along with the MIC field 312, the channel usage element(s) 302 become a source of trusted information.

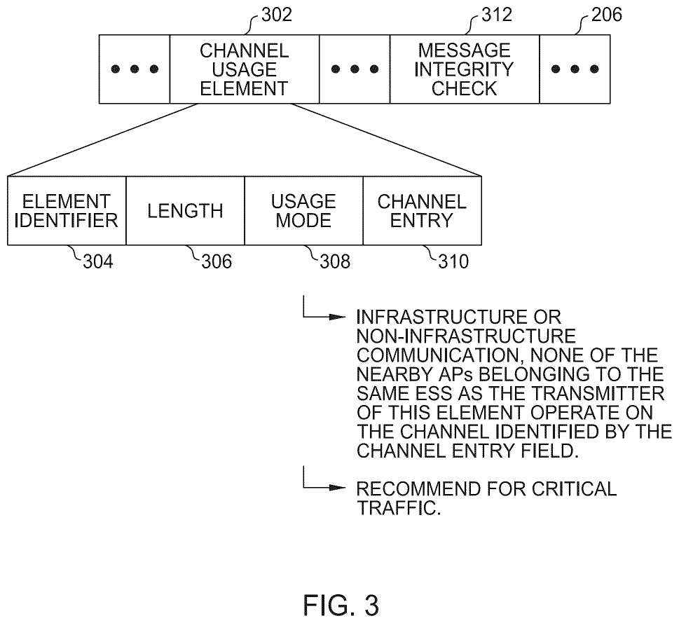

FIG. 4 is a flowchart of an example method 400 performed by the system 100 of FIG. 1A. In certain embodiments, an access point (e.g., the access point 102 shown in FIG. 1A) performs the method 400. By performing the method 400, the access point indicates that a channel is available for non-infrastructure communications.

In block 402, the access point determines that access points are refraining from using a channel. For example, the access point may scan or analyze traffic in the system to determine the channels used by access points in the same ESS as the access point. As another example, a network controller may inform the access point that other (nearby) access points in the same ESS are using the channels. The access point may then use this information to determine the channels that are not being used by the access points in the ESS. Additionally or alternatively, the network controller may inform the access point about the channels that are not being used by the access points in the ESS. These channels may be available for non-infrastructure communications (e.g., communications using an independent BSS between devices) or infrastructure communications (e.g., QoS traffic using an infrastructure BSS).

In block 404, the access point communicates a beacon indicating one or more of these channels. The beacon may include a channel usage element that indicates that these channels are available for non-infrastructure communications. For example, the channel usage element may include a channel entry field that identifies these channels, and the channel usage element may include a usage mode field that includes a value indicating that these channels are available for non-infrastructure communications. The access point may broadcast the beacon to devices within the coverage area of the access point to inform the devices that the channel is available for non-infrastructure communications.

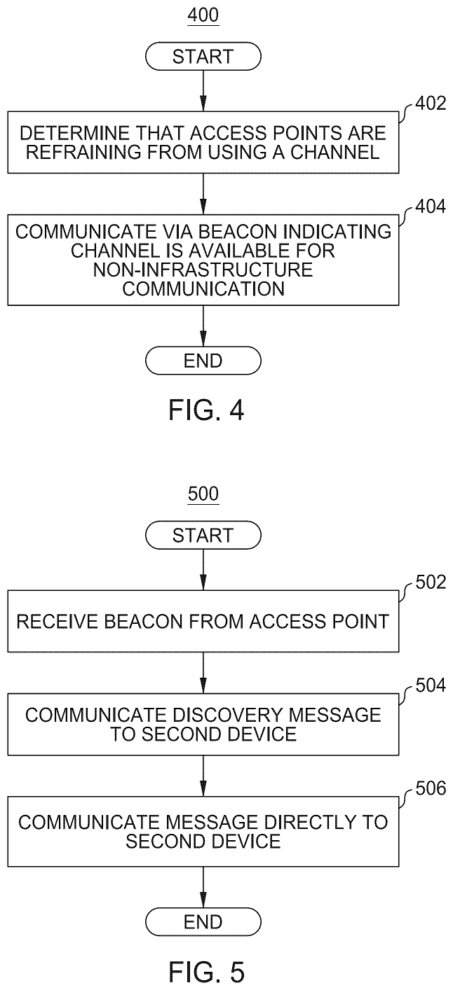

FIG. 5 is a flowchart of an example method 500 performed by the system 100 of FIG. 1A. In certain embodiments, a first device (e.g., the device 104 shown in FIG. 1A) performs the method 500. By performing the method 500, the first device establishes non-infrastructure communication with a second device while minimizing interference with the local network infrastructure.

In block 502, the first device receives a beacon from an access point that is part of the local network infrastructure. The access point may have broadcasted the beacon to the first device. The beacon may include a channel usage element that indicates that a channel is available for the device to use for non-infrastructure communications. For example, the channel usage element may include a channel entry field that identifies the channel(s), and the channel usage element may include a usage mode field that includes a value indicating that the channel(s) are available for non-infrastructure communications. There may also be an alternate or additional channel usage element that may include a channel entry field that identifies the channel(s), and the channel usage element may include a usage mode field that includes a value indicating that the channel(s) are available for non-infrastructure communications where furthermore there are no (nearby) APs operating from the transmitting AP's ESS. The first device may apply additional rules and heuristics such as one or more of: a) determining that the beacon came from an AP with trustworthy characteristics, b) determining that all (or at least multiple) nearby APs are recommending the same (or at least a non-empty intersection of) channel(s) suited to non-infrastructure communications, c) giving preference to recommended channel(s) on which there are no (nearby) APs operating from the transmitting AP's ESS d) giving preference to recommended channel(s) have relatively low channel utilization compared to other channels or have a sufficiently low channel utilization, e) excluding recommended channel(s) where there is a hardware or regulatory impediment to the client (or its anticipated peer) from using the channel(s) for P2P communications, f) giving preference to the recommended channel(s) with sufficient bandwidth and rate-versus-range characteristics. Given these rules and heuristics, the first device may then select a single channel among the recommended channels.

In block 504, the first device communicates a discovery message (e.g., a beacon) to a second device using or within the channel. The first device may start a BSS on the channel and communicate a beacon for that BSS using or within the channel. The second device may receive the beacon for the BSS to discover the first device and/or to learn the channel.

In block 506, the first device communicates a message (e.g., data) directly to the second device using or within the channel. This message may bypass the access points in the infrastructure. The message is a non-infrastructure communication (e.g., a P2P communication) between the two devices. In this manner, the first device avoids the message interfering with infrastructure communications or causing congestion for infrastructure communications.

In some embodiments, the channel width may be a punctured 20 megaHertz (MHz)/40 MHz/80 MHz/160 MHz/320 MHz. Data communications may use the whole 20-320 MHz, but only 20 MHz (e.g., the primary 20 MHZ) may be used by the first device to communicate discovery messages (e.g., the beacon) so that the second device learns the channel.

In summary, the access point 102 coordinates infrastructure and non-infrastructure communications. Generally, the access point 102 determines a channel that is not being used by access points in the infrastructure network (e.g., access points that are in the same ESS as the access point 102). The access point 102 may then communicate a message (e.g., broadcast a beacon, probe response, or (re) association response) that includes a channel usage element that identifies the channel (and potentially other channels), which indicates to nearby devices 104 that the channel (and the other channels) is available for non-infrastructure communications (e.g., P2P communications). The devices 104 may then use that channel (and/or a subset of the other channels) to communicate messages directly to each other (e.g., bypassing the infrastructure network).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
one or more memories; and
one or more processors communicatively coupled to the one or more memories, the one or more processors configured to:
determine that access points of an extended service set are refraining from using a first channel; and
communicate, to a first device, a first beacon comprising a channel usage element indicating that the first channel is available for the first device to use to communicate directly with a second device.

2. The access point of claim 1, wherein the one or more processors are further configured to communicate at least one of a probe response, an association response, or a reassociation response comprising a channel usage element indicating that the first channel is available for the first device to use to communicate directly with a second device.

3. The access point of claim 1, wherein the channel usage element comprises a channel usage mode field indicating that the first channel is available for the first device to use to communicate directly with the second device.

4. The access point of claim 1, wherein the one or more processors are further configured to communicate, to the first device, a second beacon comprising a channel usage element indicating that a second channel is available for the first device to use to communicate traffic that is subject to quality of service requirements.

5. The access point of claim 4, wherein the channel usage element further indicates that the second channel is available for access points of the extended service set to use to communicate traffic that is subject to quality of service requirements.

6. The access point of claim 1, wherein the one or more processors are further configured to receive, from a network controller, an indication that the access points of the extended service set are refraining from using the first channel, wherein determining that the access points of the extended service set are refraining from using the first channel is based on the indication.

7. The access point of claim 1, wherein the one or more processors are further configured to include, in the first beacon, a message integrity check field.

8. A method comprising:
determining that access points of an extended service set are refraining from using a first channel; and
communicating, to a first device, a first beacon comprising a channel usage element indicating that the first channel is available for the first device to use to communicate directly with a second device.

9. The method of claim 8, further comprising communicating at least one of a probe response, an association response, or a reassociation response comprising a channel usage element indicating that the first channel is available for the first device to use to communicate directly with a second device.

10. The method of claim 8, wherein the channel usage element comprises a channel usage mode field indicating that the first channel is available for the first device to use to communicate directly with the second device.

11. The method of claim 8, further comprising communicating, to the first device, a second beacon comprising a channel usage element indicating that a second channel is available for the first device to use to communicate traffic that is subject to quality of service requirements.

12. The method of claim 11, wherein the channel usage element further indicates that the second channel is available for access points of the extended service set to use to communicate traffic that is subject to quality of service requirements.

13. The method of claim 8, further comprising receiving, from a network controller, an indication that the access points of the extended service set are refraining from using the first channel, wherein determining that the access points of the extended service set are refraining from using the first channel is based on the indication.

14. The method of claim 8, further comprising include, in the first beacon, a message integrity check field.

15. An apparatus comprising:
one or more memories; and
one or more processors communicatively coupled to the one or more memories, the one or more processors configured to:
receive, from a first access point, a first beacon comprising a channel usage element indicating that a first channel is available for non-infrastructure communications; and
based on the first beacon, communicate a message directly to a device using the first channel.

16. The apparatus of claim 15, wherein the one or more processors are further configured to receive, from the first access point, at least one of a probe response, an association response, or a reassociation response comprising a channel usage element indicating that the first channel is available for non-infrastructure communications.

17. The apparatus of claim 15, wherein the channel usage element comprises a channel usage mode field indicating that the first channel is available for non-infrastructure communications.

18. The apparatus of claim 15, wherein the one or more processors are further configured to receive, from the first access point, a second beacon comprising a channel usage element indicating that a second channel is available for traffic that is subject to quality of service requirements.

19. The apparatus of claim 15, wherein the one or more processors are further configured to receive a second beacon from a second access point of an extended service set of the first access point, wherein the second beacon indicates that the first channel is available for non-infrastructure communications.

20. The apparatus of claim 15, wherein the first beacon includes a message integrity check field.
